(19) United States
(12) Patent Application Publication
(10) Pub. No.: US 2004/0130225 A1
(43) Pub. Date: Jul. 8, 2004

(54) Hybrid drive system comprising a torque converter

(76) Inventors: Georg Mencher, Bergrheinfeld (DE); Erwin Wack, Niederwerm (DE); Peter Ottenbruch, Schonungen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/477,601

(22) PCT Filed: May 10, 2002
(86) PCT No.: PCT/EP02/05134

(30) Foreign Application Priority Data
Jun. 12, 2001 (DE) 101 28 424.1

(51) Int. Cl. H02K 7/10

(52) U.S. Cl. 310/78

(57) ABSTRACT

A drive system includes a hydrodynamic coupling device having a housing assembly, which is to be connected to an input shaft for rotating therewith, and an output element, which is to be brought into drive connection with a transmission arrangement. The hydrodynamic coupling device also comprises an electric machine equipped with a rotor assembly, which is connected to the housing assembly for rotating therewith, and with a stator assembly, wherein the stator assembly is supported on a housing that surrounds the hydrodynamic coupling device at least in areas. The area of the housing which supports the stator assembly has a cooling medium channel arrangement.

### TECHNICAL AREA

The present invention pertains to a drive system comprising a hydrodynamic clutch device, especially a hydrodynamic torque converter, which has a housing arrangement to be connected to a drive shaft for rotation in common and a power takeoff element to be brought into drive connection with a transmission arrangement, where the drive system also comprises an electrical machine, comprising a rotor arrangement connected to the housing arrangement for rotation in common and a stator arrangement, where the stator arrangement is supported on a housing, which at least partially surrounds the hydrodynamic clutch device.

### STATE OF THE ART

A drive system is known from DE 199 45 475 A1, in which a rotor arrangement of the electrical machine is connected to the radially outer area of the housing arrangement of a hydrodynamic torque converter. For this purpose, a rotor bracket is welded to the housing arrangement. The stator arrangement is held in place on a nonrotating part such as the transmission.

DE 100 48 838 A1 presents a similar drive system, in which the rotor arrangement is screwed to a drive shaft together with an element that connects the hydrodynamic clutch arrangement nonrotatably to the drive shaft. The stator arrangement is supported on a housing, which radially surrounds the outside of the hydrodynamic clutch device and which also carries the transmission.

### TASK OF THE INVENTION

The task of the present invention is to provide a drive system, which, although of simple and compact design, allows the efficiency of the electrical machine to be improved.

### DESCRIPTION OF THE INVENTION

According to the invention, the task is accomplished by a drive system comprising a hydrodynamic clutch device, especially a hydrodynamic torque converter, which has a housing arrangement to be connected to a drive shaft for rotation in common and a power takeoff element to be brought into drive connection with a transmission arrangement, where the drive system also comprises an electrical machine, comprising a rotor arrangement connected to the housing arrangement for rotation in common and a stator arrangement, where the stator arrangement is supported on a housing at least partially surrounding the hydrodynamic clutch device.

In the drive system according to the invention, a coolant channel arrangement is provided in the housing in the area where the housing supports the stator arrangement.

Because a coolant channel arrangement is provided in the area of the housing in which the stator arrangement is also supported, additional heat can be carried away from the area of the stator arrangement, to which current is generally supplied. This helps to improve the efficiency of the electrical machine during its operation. This improved efficiency is especially advantageous when the essential components of a drive system of this type are surrounded by a housing, which means that the amount of heat which can be carried away by the surrounding air is reduced.

An especially easy-to-build arrangement, which also leaves a comparatively large amount of space free for the hydrodynamic clutch arrangement, can be provided by supporting the stator arrangement on a radially outer section of the housing. If the electrical machine is of the external rotor design, it is advantageous for an axially projecting stator support section to be provided on the housing; the stator arrangement can then be supported on the outer circumferential area of this support section.

In the drive system according to the invention, furthermore, it is also possible for the coolant channel arrangement to be connected to an engine coolant circuit. Of course, a separate coolant circuit could also be provided just for the electrical machine.

The housing is preferably a transmission housing.

According to another aspect of the present invention, a drive system is provided, comprising a hydrodynamic clutch device, especially a hydrodynamic torque converter, which has a housing arrangement to be connected to a drive shaft for rotation in common and a power takeoff element to be brought into drive connection with a transmission arrangement, and also comprising an electrical machine, which itself comprises a rotor arrangement connected to the housing arrangement for rotation in common and a stator arrangement.

According to the present invention, it is also provided that at least one preferably ring-shaped connecting element is attached to the housing arrangement, which element carries at least one connecting part, and that the rotor arrangement is supported on the minimum of one connecting element.

In this design, therefore, a double function is assigned to the minimum of one connecting element, the connecting part or parts of which are to be connected to the drive shaft. This simplifies the design.

It is also possible according to the invention for the minimum of one connecting element to have a rotor support section in the area radially outside the minimum of one connecting part.

According to another aspect, the present invention provides a drive system comprising a hydrodynamic clutch device, especially a hydrodynamic torque converter, which comprises a housing arrangement to be connected to a drive shaft for rotation in common and a power takeoff element to be brought into drive connection with a transmission arrangement, and also comprising an electrical machine, which itself comprises a rotor arrangement connected to the housing arrangement for rotation in common and a stator arrangement.

According to another aspect of the present invention, it is also provided in this drive system that the rotor arrangement is supported on at least one rotor support element connected by welding to the housing arrangement. This minimum of one rotor support element is connected by welding to the housing arrangement in at least two areas a certain axial distance apart.

In this way a very stable connection is established between the rotor arrangement and the housing arrangement, so that, especially when torque is to be introduced via the rotor arrangement to the drive train, the deformations which could be caused by the forces acting in the area of the housing arrangement can be significantly reduced.

With this design of the drive system according to the invention, it can also be provided that the rotor arrangement is essentially located axially between the minimum of two welded areas.

The present invention is described in detail below with reference to the attached drawings on the basis of preferred embodiments:

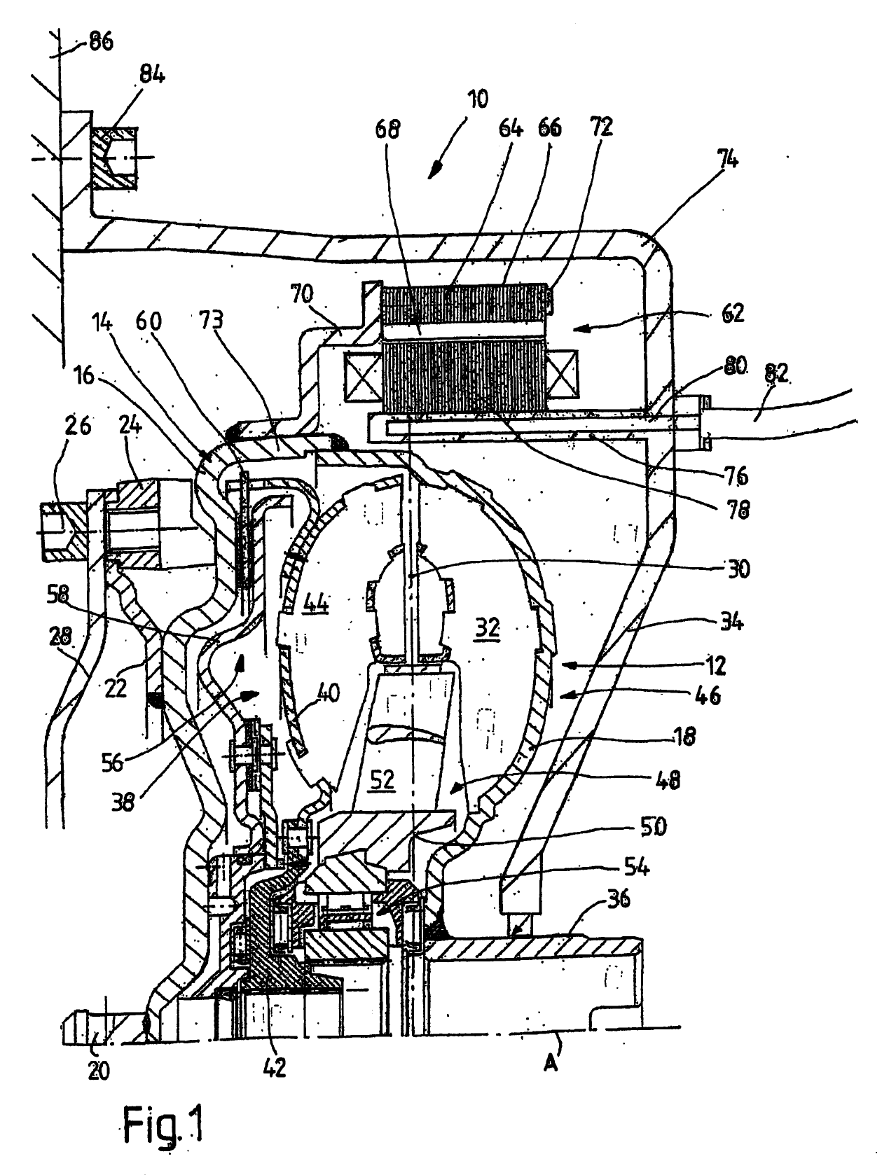

FIG. 1 shows a partial axial cross-sectional view of a first embodiment of a drive system according to the invention;

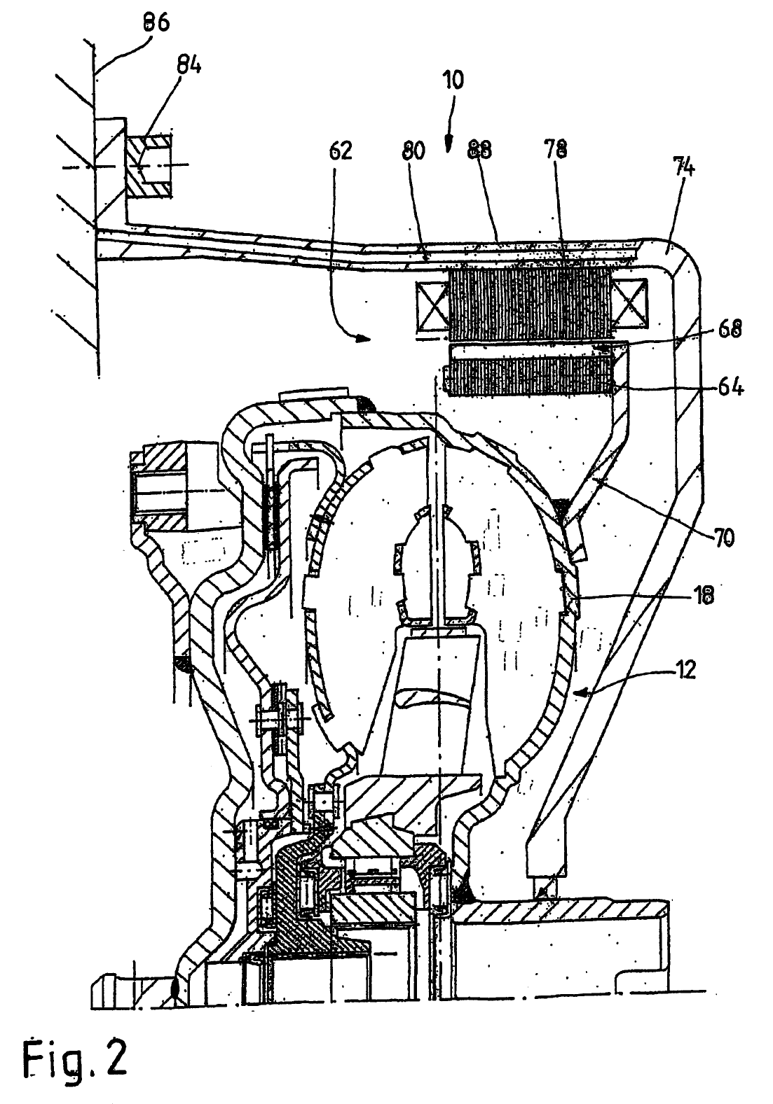

FIG. 2 shows a view, corresponding to FIG. 1, of an alternative embodiment;

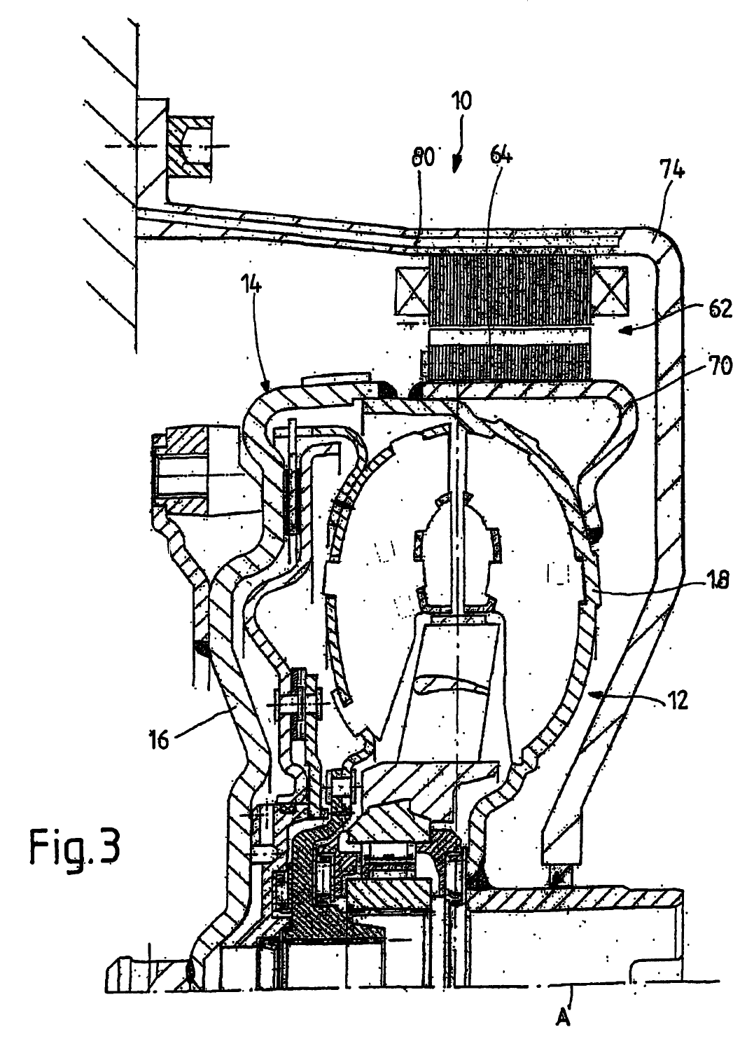

FIG. 3 shows another view, corresponding to FIG. 1, of an alternative embodiment; and

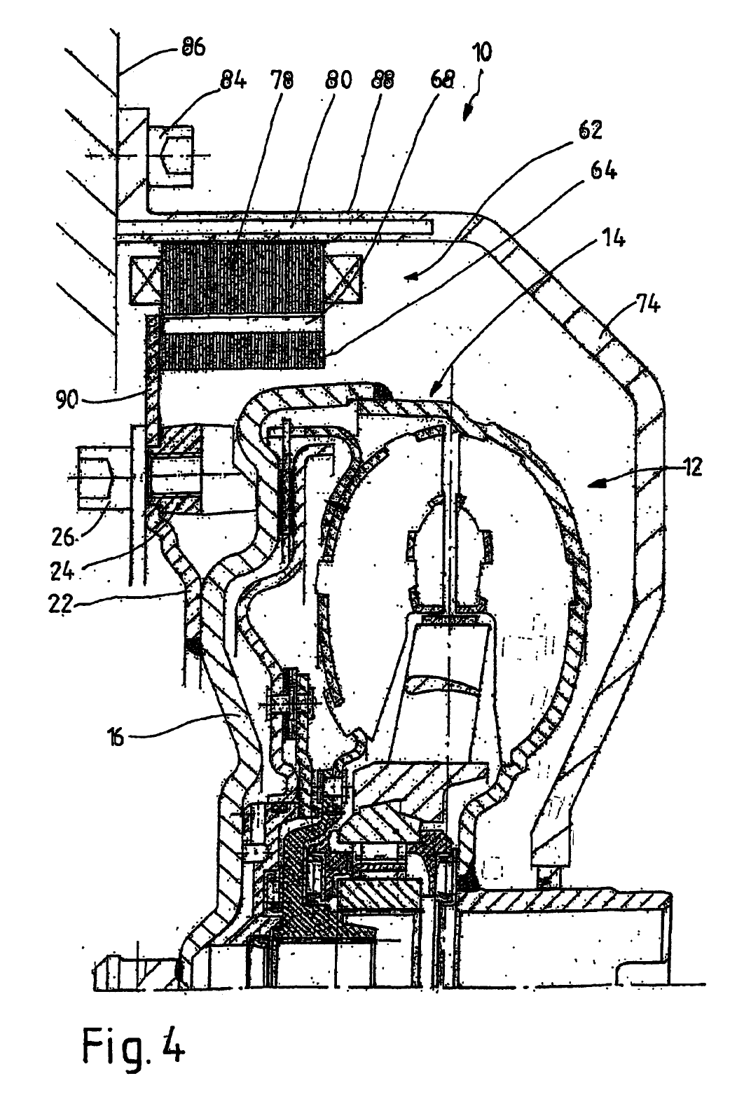

FIG. 4 shows another view, corresponding to FIG. 1, of an alternative embodiment.

FIG. 1 shows a drive system according to the invention, designated 10 overall. This drive system 10 comprises a hydrodynamic clutch device in the form of a hydrodynamic torque converter 12. The hydrodynamic torque converter 12 has a housing arrangement 14, which in turn comprises a housing cover 16 and a pump wheel shell 18. The housing cover 16 carries in its radially inner area a guide journal 20, which is concentric to the axis of rotation A and can be inserted into an appropriately formed opening in a drive shaft (not shown), such as the crankshaft of an internal combustion engine. In addition, the housing cover 16 also carries a connecting element 22, possibly designed with a ring-like shape, which is welded to the cover. This connecting element itself carries in its radially outer area, distributed in the circumferential direction around the axis of rotation A, several connecting parts 24, which can be designed, for example, as nut elements. Into these, fastening screws 26 are screwed, by means of which the radially outer area of a connecting disk 28, designed as, for example, a flexplate, is connected to the connecting element 22 and thus to the housing arrangement 14. In its radially inner area, this connecting disk 28 is then screwed in the conventional manner to the drive shaft.

On the side facing the interior 30 of the housing, the pump wheel shell 18 carries a plurality of pump wheel vanes 32. In its radially inner area, the pump wheel shell 18 is rigidly connected to a pump wheel hub 36, which extends through an end wall 34 of the housing.

In the interior 30 of the housing, furthermore, a turbine wheel, designated 38 overall, is provided. The turbine wheel 38 comprises a turbine wheel shell 40, which is connected in the radially inner area to a turbine wheel hub 42 and which carries a plurality of turbine wheel vanes 44. The turbine wheel hub 42 can be connected nonrotatably in the conventional manner to a power takeoff element, such as a transmission input shaft (not shown), concentric to the pump wheel hub 36, by means of a set of wedge-shaped teeth.

A stator 48 is installed between the turbine wheel 38 and the pump wheel 46, which comprises essentially the pump wheel shell 18, the pump wheel vanes 32, and the pump wheel hub 36. The outer circumferential area of a stator ring 50 carries a plurality of stator vanes 52 and is supported in such a way via a freewheel arrangement 54 on a support element (not shown), such as a hollow support shaft, that it, together with the stator vanes 52, is free to rotate in one direction around the axis of rotation A but is blocked from rotating in the other direction.

It should also be pointed out that the hydrodynamic torque converter 12 has a bridging clutch arrangement, designated 56 overall, with a clutch piston 58. This piston can be pressed toward the housing cover 16 by an appropriate increase in hydraulic pressure, so that, by way of a disk 60, which is connected nonrotatably to the turbine wheel 38 and carries friction linings, a direct, mechanical, torque-transmitting connection can be established between the housing arrangement 14 and the turbine wheel 38 under at least partial “bridging” of the otherwise prevailing fluid circulation.

The drive system according to the invention also has an electrical machine, designated 62 overall. The electrical machine 62 comprises a rotor arrangement 64. This has, for example, a plurality of sheet-metal elements 66 resting against each other, which, in the example illustrated here, carry a plurality of permanent magnets 68 on their inner circumferential side. The rotor arrangement 64 is fastened to a rotor support element 70, designed in the form of, for example, a ring, by means of, for example, several screw bolts 72. In the exemplary embodiment shown in FIG. 1, the rotor support element 70 is connected in turn by welding to the radially outer, essentially axially oriented section 73 of the housing cover 16.

The axial end wall 34 of a housing 74, which encloses the hydrodynamic torque converter 12 essentially completely, has an axially projecting stator support section 76. This can be designed to extend continuously in a ring-like manner in the circumferential direction around the axis of rotation A, but it could also be made up of several sections. On an outer circumferential side of the stator support section 76, a stator arrangement 78 of the electrical machine 62 is supported, which can have windings wound around a yoke in the conventional manner. In the present case, the stator arrangement 78 lies radially directly inside the rotor arrangement 64, which means that the electrical machine 62 is designed in the manner of an external rotor machine.

It can also be seen in FIG. 1 that a coolant channel arrangement 80 is provided in the stator support section 76. This can be connected by a hose connection 82 to the engine coolant circuit, for example, but it can also be connected to a separate coolant circuit. By conducting coolant through the coolant channel arrangement 80, it is ensured that the heat generated in the area of the electrical machine 62 is carried away. This is important especially in the case of the arrangement shown in FIG. 1, because here both the electrical machine 62 and the hydrodynamic torque converter 12 are essentially completely enclosed by the housing 74, and thus it is essentially impossible for the ambient air to flow around them to dissipate the heat. The housing 74 can be, for example, a part of the housing of a transmission (not shown), which is to be brought into torque-transmitting connection with the main (drive) engine by the hydrodynamic torque converter 12. On the axially open side, the housing 74 can be tightly screwed by several screw bolts 84, for example, to an engine block 86 or the like.

In the embodiment shown in FIG. 1, a very compact design is achieved, in which it is ensured that the hydrodynamic torque converter 12 can be connected in the conventional manner, that is, for example, by the use of a so-called flexplate, to the drive shaft. A torque can also be introduced by the electrical machine 62 into the drive train in order, for example, to start the main engine. Of course, a drive torque can also be supplied by the electrical machine 62. When the main engine is running, electrical energy can then be recovered by the electrical machine 62, which thus acts as a generator, and this energy can be stored in a battery.

To assemble the arrangement shown in FIG. 1, it is possible to proceed by first attaching the stator arrangement 78 to the stator support section 76. Then the rotor arrangement 64 is connected to the rotor support element 70, which has already been welded to the housing arrangement 14. Thus a preassembled unit is formed, which comprises the hydrodynamic torque converter 12 and the rotor arrangement 64. This unit is then introduced into the housing 74 and connected to the transmission (not shown) for the transmission of torque. The module thus formed is then brought axially into position against the main engine, to the drive shaft of which the connecting disk 28 has already been attached. Then, by means of openings provided in, for example, the housing 74 or in the engine block, the screw bolts 26 can be inserted and tightened, and thus the solid connection of the housing arrangement 14 to the drive shaft is accomplished.

A modified embodiment of the drive system 10 according to the invention is illustrated in FIG. 2. In the following, only the differences with respect to the embodiment described in reference to FIG. 1 will be discussed.

First, it is possible to see that the stator arrangement 78 is no longer supported on a stator support section especially provided for it; instead, it is attached to a radially outer, approximately cylindrical area 88 of the housing 74 in such a way that it essentially overlaps the pump wheel shell 18 in the axial direction. The ring-like rotor support element 70 is now attached to the pump wheel shell 18 by means of welding, for example, and again carries in its radially outer area the rotor arrangement 64 with its permanent magnets 68, which are now located radially on the outside. A machine of the internal rotor type is therefore obtained. The coolant channel arrangement 76 is now provided in the radially outer area 88 of the housing 74; this channel arrangement is open on the axially open side of the housing 74 and can therefore be connected very easily to the coolant circuit of the engine.

Because, in the modified embodiment shown in FIG. 2, the stator arrangement 78 is connected directly to an area of the housing 74 surrounded by ambient air, it is possible to provide the stator arrangement 78 with a more effective cooling action.

In the case of the embodiment shown in FIG. 3, which is essentially the same as that shown in FIG. 2, the ring-shaped rotor support element 70 is connected by welding not only at one axial end area to the housing arrangement 14, i.e., to the pump wheel shell 18. The ring-shaped rotor support element 70 is now also connected by welding to the housing arrangement 14 (i.e., the pump wheel shell 18 in the example shown here) at the other axial end area, that is, at the axial end area near the connection between the pump wheel shell 18 and the housing cover 16. The rotor arrangement 64 is located essentially between these two axially offset welded areas. A very stable connection of the rotor arrangement 64 to the housing arrangement 14 is thus obtained without the danger of generating tilting torques or excessive deformations in the area of the housing arrangement 14.

Another modified embodiment of the drive system 10 according to the invention is shown in FIG. 4. Here, too, essentially only the differences with respect to the previous embodiments will be discussed.

First, it can be seen that the electrical machine 62 in this embodiment is closer to the main engine, i.e., to the engine block 86 of that engine, and essentially overlaps the housing cover 16 of the housing arrangement 14 in the axial direction. The stator arrangement 78 is again attached to the radially outer, essentially cylindrical area 88 of the housing 74. The rotor arrangement 64 is again radially inside the stator arrangement 78, so that again an electrical machine 62 of the internal rotor type is obtained.

It can be seen in FIG. 4 that the ring-shaped connecting element 22 is extended in the radially outward direction beyond the area where its carries the connecting parts 24, and in this outer, extended area it forms a rotor support section 90. The rotor arrangement 64 can then be attached by means of, for example, screw bolts again or the like to this rotor support section 90, which can be in the form of a ring or which can be tongue-like with several projections. In this way, a very easy-to-construct and also very compact arrangement is created, in which, furthermore, very effective cooling can be provided for the stator arrangement.

The present invention provides a drive system which, although compact, makes it possible to integrate a hydrodynamic clutch device, such as a hydrodynamic torque converter, and an effectively cooled electrical machine, which acts as a crankshaft starter-generator, in a single housing. It is obvious that various parts of the drive system according to the invention can be designed differently from the way shown in the figures. For example, the illustrated hydrodynamic torque converter is only one example of these types of torque converters. Of course, a fluid clutch could also be used in place of a torque converter. It is also obvious, for example, that, in the design variant shown in FIG. 1, the stator support section of the housing could be designed as a separate component instead of as an integral piece as shown. It is also obvious, furthermore, that the housing shown in the figures can be designed in various ways to adapt it to the various types of engine blocks and/or various transmission arrangements. This housing is preferably a part of the transmission housing, however, because of the simplicity of design and construction thus offered. It should also be pointed out, even though it is obvious, that the coolant channel arrangement can have various configurations with respect to the path of the channels, such as a meander-like configuration. Several coolant inlets and/or outlets can also be provided, as is also obvious.

We I claim:

1. Drive system comprising:
a hydrodynamic clutch device (12), especially a hydrodynamic torque converter, which has a housing arrangement (14) to be connected to a drive shaft for rotation in common and a power takeoff element to be brought into drive connection with a transmission arrangement;
an electrical machine (62), comprising a rotor arrangement (64) connected to the housing arrangement (14) for rotation in common and a stator arrangement (78), where the stator arrangement (78) is supported on a housing (74), which at least partially surrounds the hydrodynamic clutch device (12),
characterized in that the housing (74) has a coolant channel arrangement (80) in the area (76; 88) supporting the stator arrangement (78).

2. Drive system according to claim 1, characterized in that the stator arrangement (78) is supported on a radially outer section (88) of the housing (74).

3. Drive system according to claim 1, characterized in that an axially projecting stator support section (76) is provided on the housing (74), and in that the stator arrangement (78) is supported on an outer circumference of the stator support section (76).

4. Drive system according to one of claims 1-3, characterized in that the coolant channel arrangement (80) is designed to be connected to an engine coolant circuit.

5. Drive system according to one of claims 1-4, characterized in that the housing (74) is a transmission housing.

6. Drive system comprising:
a hydrodynamic clutch device (12), especially a hydrodynamic torque converter, which has a housing arrangement (14) to be connected to a drive shaft for rotation in common and a power takeoff element to be brought into drive connection with a transmission arrangement;
an electrical machine (62), comprising a rotor arrangement (64) connected to the housing arrangement (14) for rotation in common and a stator arrangement (78), optionally in association with one or more of the features of the preceding claims, characterized in that at least one preferably ring-like connecting element (22) is attached to the housing arrangement (14), which element carries at least one connecting part (24), and in that the rotor arrangement (64) is supported on the minimum of one connecting element (22).

7. Drive system according to claim 6, characterized in that the minimum of one connecting element (22) has a rotor support section (90) in the area radially outside the minimum of one connecting part (24).

8. Drive system comprising:
a hydrodynamic clutch device (12), especially a hydrodynamic torque converter, which has a housing arrangement (14) to be connected to a drive shaft for rotation in common and a power takeoff element to be brought into drive connection with a transmission arrangement;
an electrical machine (62), comprising a rotor arrangement (64) connected to the housing arrangement (14) for rotation in common and a stator arrangement (78), where the rotor arrangement (64) is supported on at least one rotor support element (70), which is connected by welding to the housing arrangement (14), optionally in connection with one or more of the features of the preceding claims, characterized in that the rotor support element (70) is connected by welding to the housing arrangement (14) in at least two areas a certain axial distance apart.

9. Drive system according to claim 8, characterized in that the rotor arrangement (64) is located axially essentially between the minimum of two welded areas.
